(19) United States
(12) Patent Application Publication
(10) Pub. No.: US 2005/0203705 A1
(43) Pub. Date: Sep. 15, 2005

(54) Vehicle driving control device and vehicle control unit

(75) Inventors: Shiho Izumi, Hitachi (JP); Satoru Kuragaki, Isehara (JP); Takao Kojima, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 10/929,520

(22) Filed: Aug. 31, 2004

(30) Foreign Application Priority Data
Mar. 9, 2004 (JP) 2004-065127

(51) Int. Cl. G08G 1/16

(52) U.S. Cl. 701/301; 340/903; 340/436

(57) ABSTRACT

A vehicle driving control device includes a body detection mechanism for detecting a body existing forward of a driver's own vehicle, a driver's own vehicle speed detection mechanism for detecting velocity of the driver's own vehicle, a steering control mechanism for controlling steering angle of steered wheels on the basis of operation of a steering wheel, a body-size detection mechanism for detecting size of the body, and a control-characteristics change mechanism for changing control characteristics of the steering control mechanism on the basis of position information on the body detected by the body detection mechanism, the size information on the body, and the velocity information on the driver's own vehicle. When the driver tries to avoid collision by handle operation, it becomes possible to avoid a collision in a direction in which the driver has turned the handle, and also prevents over-operation from occurring.

### BACKGROUND OF THE INVENTION

1. Field of the Invention

The present invention relates to improvements of a vehicle driving control device and a vehicle control unit for assisting driving state of a driver's own vehicle by recognizing driving environment of the vehicle using a sensor such as a radar or an image sensor like a camera for monitoring surroundings of the vehicle.

2. Description of the Related Art

From conventionally, there has been known a device for assisting driving of a vehicle in such a manner that, if the vehicle is in a danger of colliding with a forward-positioned obstruction body, the collision with the obstruction body will be able to be avoided. For example, in a device described in JP-A-7-137590, if the device has judged that an avoidance operation by driver alone will fail to avoid the collision, the device increases braking force of the vehicle, thereby making it possible to avoid the collision. Moreover, in JP-A-2000-177616, a disclosure has been made concerning an emergency-time driving assistance device for enhancing avoidance performance of the vehicle if the use of the above-described technique finds it difficult to stop the vehicle before the obstruction body. In the device described in JP-A-2000-177616, operation gain of a steering actuator corresponding to operation of a steering wheel (i.e., handle) is made larger at emergency time as compared with normal time, thereby enhancing the cornering performance of the vehicle.

### SUMMARY OF THE INVENTION

Under the judgment of being emergency time in which the operation gain of the steering actuator corresponding to a handle operation is made larger across the board, it is preferable not to, depending on size of the obstruction body or the surrounding environment, make the collision avoidance difficult to achieve. Furthermore, it is also preferable not to make an avoidance operation too large, for causing an even more dangerous situation not to occur.

It is an object of the present invention to execute best-fitted collision-avoidance assistance in response to the size of a forward-positioned obstruction body, and thereby to enhance operability of the collision avoidance when driver tries to avoid the collision by steering operation.

In a preferred aspect of the present invention, there is provided a control-characteristics change function for changing control characteristics of a control mechanism related with steering of a vehicle in response to size of an obstruction body including transverse width of the forward-positioned obstruction body of the vehicle.

Here, as a method for changing the control characteristics of the control mechanism related with the steering of the vehicle, there exists a method of changing steering angle of steered wheels corresponding to operation amount of the steering wheel so that the steering azimuth angle will become larger in response to the size of the obstruction body.

Also, it is preferable that the control-characteristics change function include a function of changing assistance force by a power steering device so that the assistance force will become larger in response to the size of the obstruction body.

Moreover, it is preferable that the control-characteristics change function include a function of exerting braking force onto a front wheel positioned in a direction in which the steering wheel is operated, the braking force being larger than braking force exerted onto the other front wheel.

According to the present invention, when a vehicle is in a danger of colliding with a forward-positioned obstruction body, and the driver performs the collision-avoidance operation, it becomes possible to perform the collision-avoidance operation assistance in response to size of the obstruction body. This best-fitted assistance allows the implementation of an enhancement in operability and safety of the driving.

### BRIEF DESCRIPTION OF THE DRAWINGS

FIG. 1 illustrates an entire configuration diagram of a vehicle driving control device according to a first embodiment of the present invention;

FIGS. 2A and 2B illustrate an operation-principle explanatory diagrams for explaining a radar device of the two-frequency CW scheme used as a body detection unit;

FIGS. 3A and 3B illustrate a plan view and a FFT waveform diagram of a situation where the radar device detects a forward-positioned body;

FIG. 4 illustrates a plan view for illustrating an example of the operation situation where the radar device detects the forward-positioned bodies;

FIGS. 5A and 5B illustrate plan views for illustrating a method for setting a zone DZ which is dangerous for the driver's own vehicle;

FIG. 6 illustrates a plan view for explaining an estimation method for estimating the vehicle position which accompanies time variation;

FIG. 7 illustrates a configuration diagram of a concrete embodiment of the present invention using a VGR-equipped steering driving-force transmission mechanism;

FIG. 8 illustrates an explanatory diagram for explaining an adjustment example of the steering gear ratio in an embodiment of the present invention;

FIG. 9 illustrates an explanatory diagram for explaining an adjustment example of brake-force instructions in an embodiment of the present invention;

FIG. 10 illustrates a processing flow for illustrating a first embodiment of the computation processing in the vehicle control ECU;

FIG. 11 illustrates a processing flow for illustrating a second embodiment of the computation processing in the vehicle control ECU;

FIG. 12 illustrates a processing flow for illustrating a third embodiment of the computation processing in the vehicle control ECU;

FIG. 13 illustrates a processing flow for illustrating a fourth embodiment of the computation processing in the vehicle control ECU; and

FIG. 14 illustrates a configuration diagram for illustrating a concrete embodiment of the present invention using a SBW-schemed steering driving-force transmission mechanism.

### DESCRIPTION OF THE EMBODIMENTS

Hereinafter, referring to the drawings, the explanation will be given below concerning embodiments of the present invention.

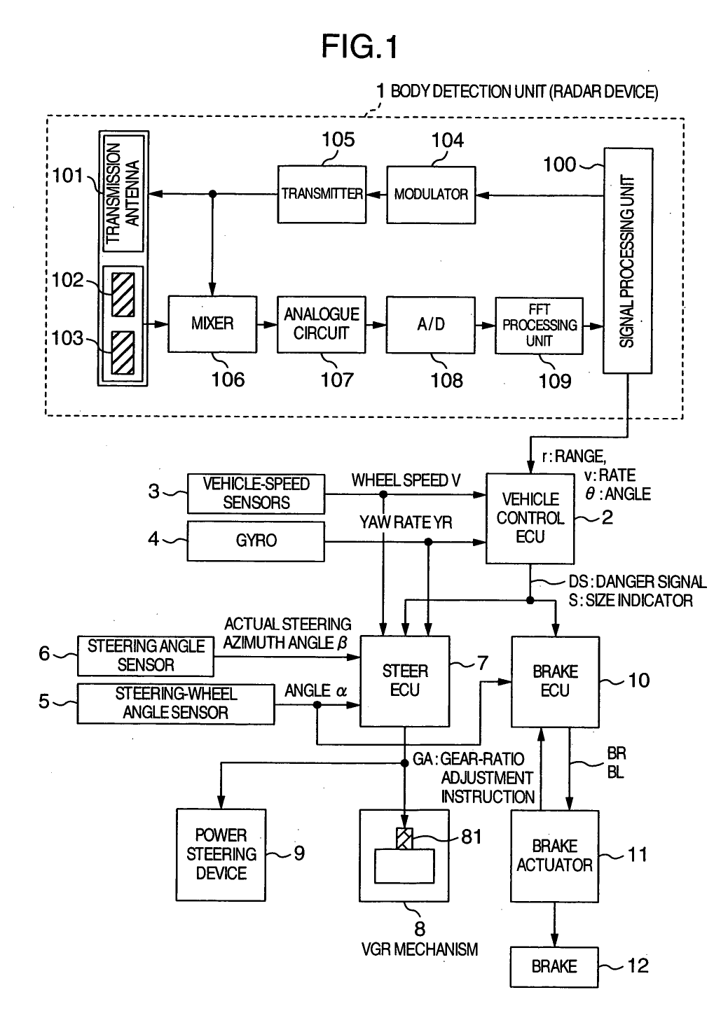

FIG. 1 illustrates an entire configuration diagram of a vehicle driving control device according to a first embodiment of the present invention. A body detection unit 1 detects a body existing in surroundings of the driver's own vehicle. Concretely, as the sensor, a radar device is preferable which performs irradiation with light or electromagnetic waves thereby to detect the body and to make its velocity or position detectable. Otherwise, a device is usable which uses image recognition thereby to perform the distance- or range-detection up to the body or the body recognition. This body detection unit 1, at its signal processing unit 100, computes and outputs, to a vehicle control ECU (: Electronic Control Unit) 2, distance r between the driver's own vehicle and the body, forward-directed angle θ which the vehicle forms with respect to the body, and relative velocity, or rate v between the vehicle and the body. The inside of this body detection unit 1 will be explained in more detail later.

Now, vehicle-speed sensors 3 detect wheel speed V of the driver's own vehicle, and a gyro 4 detects yaw rate YR. These pieces of information V and YR are inputted into the vehicle control ECU 2. Based on the above-described outputs r, v, and θ from the body detection unit 1 and the above-described detected information V and YR, the vehicle control ECU 2 computes size indicator S including transverse width W of the body, dangerous zone DZ, and position of the driver's own vehicle 13 after that. If, as the result, the ECU 2 has judged that the driver's own vehicle 13 is in a danger of dashing into the dangerous zone DZ, the ECU 2 issues a danger signal DS. This danger signal DS is inputted into a steer ECU 7 together with the size indicator S or the like of the obstruction body 14.

A handle (i.e., steering wheel) angle sensor 5 detects angle α of the handle operated by the driver. Actual steering angle β of the wheels steered by this operation is detected by a steering angle sensor 6. The steer ECU 7 inputs the detected outputs from the vehicle-speed sensors 3, the gyro 4, the handle angle sensor 5, and the steering angle sensor 6. Simultaneously, the steer ECU 7, from the computation result at the vehicle control ECU 2, inputs the danger signal DS for indicating the danger of collision with the forward-positioned obstruction body, and the size indicator S including the transverse width W of the obstruction body. As will be explained later, the size indicator S of the obstruction body is an indicator for indicating the size of the obstruction body which, of dimensions of the forward-positioned obstruction body, includes the dimension in the direction perpendicular to a traveling direction of the driver's own vehicle, i.e., the transverse width W. The size indicator may be the transverse width W alone. In other words, the size indicator is an indicator for indicating the degree of difficulty in collision avoidance by the handle operation.

If, at the ECU 2, it has been judged that there exists the danger of actual collision, and if the danger signal DS has been inputted into the steer ECU 7, the steer ECU 7 sends out a change instruction GA of changing steering gear ratio G to a VGR (: Variable Gear Ratio) mechanism 8. Namely, based on the inputted information starting with the size indicator S of the obstruction body, the steer ECU 7 computes the instruction value G* of the steering gear ratio G, then outputting the computed instruction value to the VGR mechanism 8 and a power steering (which, hereinafter, will be abbreviated as “power-steer”) device 9.

This steering gear ratio G is defined as a ratio between the handle operation amount α and the actual steering angle β of the steered wheels (i.e., G=α/β). If this steering gear ratio G is made small, the steering angle β of the steered wheels which is larger than usual can be acquired with a small handle operation amount α. In an embodiment of the present invention, the VGR mechanism 8 is operated using a motor 81, thereby adjusting the steering gear ratio G.

On account of this effect, when there appears a forward-positioned obstruction body with which the vehicle is in a danger of colliding, the larger the transverse width W of the obstruction body is, the larger cornering of the vehicle it becomes possible to acquire with a small handle operation. This allows the implementation of an enhancement in the safety.

The steering-gear-ratio change instruction GA is outputted to the power-steer device 9 as well. Accordingly, it is desirable that assistance force by the power-steer device 9 be strengthened in response to the size indicator S of the obstruction body.

Meanwhile, the danger signal DS and the size indicator S of the obstruction body from the above-described vehicle control ECU 2 are inputted into a brake ECU 10 as well. The brake ECU 10, if it is given the danger signal DS, controls a brake 12 via a brake actuator 11 so that brake force in a right or left direction in which the handle has been turned will be increased in response to the size indicator S of the obstruction body. As a result of this, when there appears the forward-positioned obstruction body with which the vehicle is in a danger of colliding, the brake force in the right or left direction in which the driver has turned the handle to try to avoid this obstruction body is increased as the transverse width W of the obstruction body is larger. Consequently, the larger cornering of the vehicle in the desired direction is acquired with the small handle operation. At this time, it turns out that total brake force has been increased. This allows the implementation of an even further enhancement in the safety.

Here, the explanation will be given below concerning an example where, with respect to the case of using the radar device as the body detection unit 1, the size indicator S including the transverse width W of the body is detected based on reflected waves reflected from respective points on the body.

First of all, the explanation will be given below regarding a measurement method for measuring, by using the radar device, the distance r and relative velocity v between the driver's own vehicle and the forward-positioned obstruction body. An antenna unit includes a transmission antenna 101 and reception antennas 102 and 103. A traveling wave, e.g., a high-frequency signal in millimeter-wave band, is transmitted from a transmitter 105 at a transmission frequency based on a modulated signal from a modulator 104. Then, this traveling wave is radiated from the transmission antenna 101. Moreover, the electromagnetic wave, which has returned by being reflected by reflection bodies existing in surroundings of the vehicle, is received at the reception antennas 102 and 103, then being frequency-transformed in a mixer circuit 106. Here, the signal from the transmitter 105 has been supplied to this mixer circuit 106 as well. As a result, a low-frequency signal is generated by mixing of these two signals, then being outputted to an analogue circuit 107. Furthermore, the low-frequency signal, which is amplified and outputted at the analogue circuit 107, is converted into a digital signal by an A/D converter 108. The digital signal is supplied to a FFT (: Fast Fourier Transformation) processing unit 109, where, using Fast Fourier Transformation, frequency spectrum of the signal is measured as information on amplitude and phase. Then, the frequency spectrum is sent to the signal processing unit 100. From the data in the frequency area acquired in the FFT processing unit 109, the signal processing unit 100 computes the distance r up to the body, forward-directed angle θ which the vehicle forms with respect to the body, and relative velocity v.

Here, the following two-frequency CW (: Continuous Wave) scheme is used: Namely, the relative velocity v between the driver's own vehicle and the body is measured using Doppler Shift. Next, two frequencies are switched to each other, thereby measuring the distance r up to the body from phase information on received signals at the respective two frequencies. The distance measurement value r, angle measurement value θ, and relative-velocity measurement value v acquired in this way are outputted to the vehicle control ECU 2.

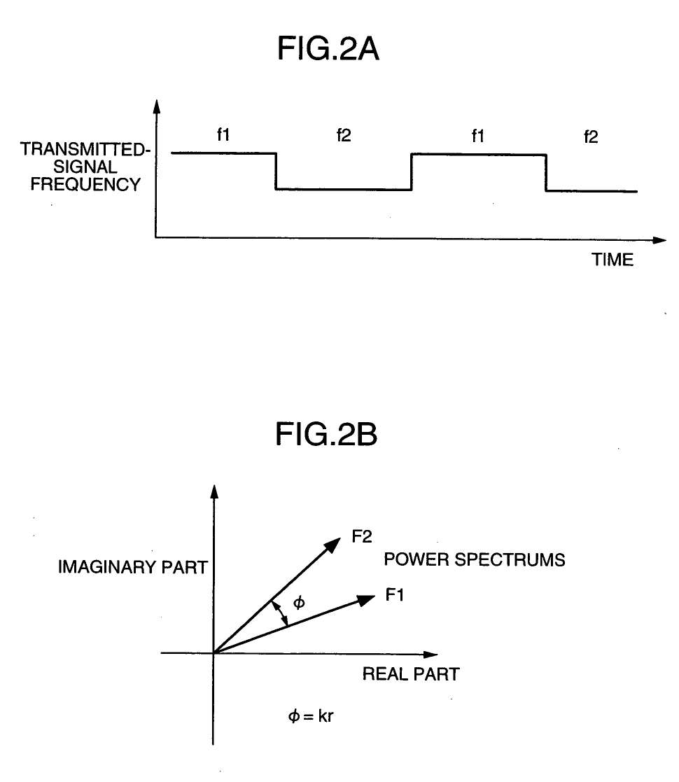

FIG. 2 illustrates an operation-principle explanatory diagram for explaining the radar device of the two-frequency CW scheme used as the body detection unit 1 in the first embodiment of the present invention. In the case of the two-frequency CW scheme, a modulated signal is inputted into the transmitter 105, then transmitting two frequencies f1 and f2 while switching the two frequencies to each other in time as are illustrated in FIG. 2A. Then, the electromagnetic wave transmitted from the transmission antenna 101 is reflected at a forward-positioned object, and the reflected signal is received at the reception antennas 102 and 103. Next, the received signal and the signal from the transmitter 105 are mixed by the mixer 106, thereby acquiring a beat signal resulting from the two signals. In the case of Homodyne scheme where the direct conversion into Baseband is performed, frequency of the beat signal outputted from the mixer 106 becomes equal to Doppler frequency fd, which is calculated by an expression (1).
[Expression 1]

$$V = \frac{cfd}{2 fc} \qquad ( 1 )$$

Here, fc denotes carrier frequency, v denotes the relative velocity, and c denotes speed of light. On the reception side, the received signals at the respective transmission frequencies f1 and f2 are separated and demodulated in the analogue circuit 107. Moreover, the received signals corresponding to the respective transmission frequencies undergo A/D conversion in the A/D converter 108. Digital sample data acquired by the A/D conversion is subjected to the Fast Fourier Transformation processing in the FFT processing unit 109, thereby acquiring frequency spectrum of the received beat signal in entire frequency bandwidth. Furthermore, with respect to a peak signal acquired as the result of the FFT processing, based on the principle of the two-frequency CW scheme, power spectrums F1 and F2 (as illustrated in FIG. 2B) of the peak signals corresponding to the respective transmission frequencies f1 and f2 are measured. Then, the distance r is calculated from phase difference φ between the two power spectrums, using the following expressions (2) and (3):
[Expression 2]

$$\begin{matrix}r = \frac{c ϕ}{4 πΔ f} & ( 2 ) \\ Δ f = f2 - f1 & ( 3 )\end{matrix}$$

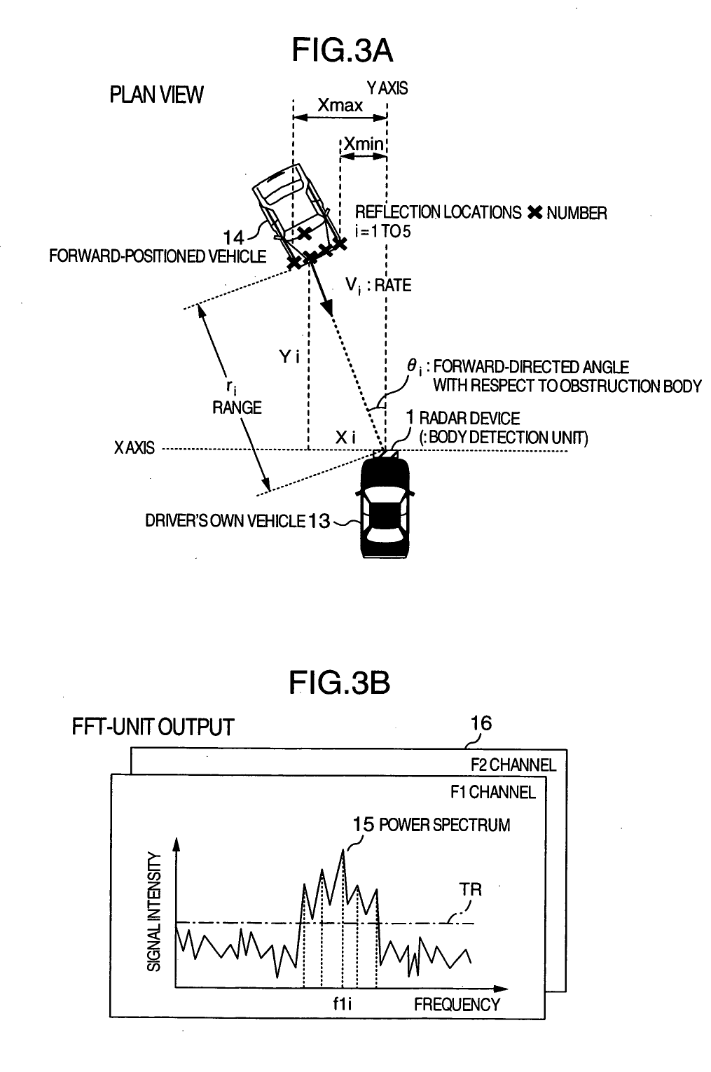

FIG. 3 illustrates a plan view and a FFT waveform diagram of the situation where the radar device 1 mounted on the driver's own vehicle 13 detects the forward-positioned body 14. FIG. 3B illustrates the power spectrum 15 of the peak signal corresponding to the transmission frequency f1 in the example where, as illustrated in FIG. 3A, the driver's own vehicle 13 mounting the radar device 1 at the front thereof detects the forward-positioned vehicle 14. This power spectrum 15 is a result acquired by performing the FFT processing to reflected waves at frequencies f1i (i: number of reflection locations; i=1 to 5 in this example) from the detected vehicle 14. The power spectrum 16 of the peak signal corresponding to the transmission frequency f2 can also be acquired in much the same way. Moreover, peak signals at these frequencies f1i (i=1 to 5) are detected. Then, the relative velocity v and distance r with respect to the vehicle 14 can be calculated from these frequencies, using the expressions (1) and (2).

If, selecting as the reference the radar device 1 mounted on the driver's own vehicle 13, velocities (i.e., relative velocities v with respect to the driver's own vehicle) at the respective reflection points on the detected vehicle 14 differ from each other, the velocity distribution appears with reference to the frequency axis as is illustrated in FIG. 3B. Accordingly, first of all, peak values are calculated for which the signal intensities are larger than, a predetermined value (i.e., threshold level) TL. Next, calculations of the relative velocity v, distance r, and angle θ are performed for each of the peak values detected. Here, in a coordinate system whose point of origin is defined as the radar device 1 and whose y-axis is defined as traveling direction of the driver's own vehicle 13, assume that position coordinate of each of the detected reflection points is (Xᵢ, Yᵢ). Also, assuming that the distance and the angle with respect to each of the detected reflection points on the vehicle 14 are rᵢ and θᵢ respectively, the detected position coordinate can be represented by expressions (4) and (5).
Xᵢ=rᵢsinθᵢ (4)
Yᵢ=rᵢcosθᵢ (5)

Next, reflection cross-section areas σᵢ at the detected reflection points whose number is defined as being k, where “k” is a number of reflection points, are calculated by the following expression:

$$10 log {σ}_{i} = 40 log ( {r}_{i} ) + 10 log Pr - 10 log \{ PtGtGr {λ}^{2} + 30 log ( 4 π ) \} \qquad ( 6 )$$

Here, Pr, Pt, Gt, Gr, and λ denote radar's reception electric power, radar's transmission electric power, transmission antenna gain, reception antenna gain, and the wavelength, respectively.

Next, of the position coordinates of the respective reflection points on the forward-positioned vehicle 14, the smallest x coordinate and largest x coordinate in the x-axis direction are defined as Xmin and Xmax, respectively. Then, the transverse width W of the vehicle 14 with respect to the driver's own vehicle 14 is represented by an expression (7).
W=X max−X min (7)

Here, summation of the dimension of the body 14 in the x-axis direction, i.e., information on the transverse width W of the body 14, and average value σᵢ/k of the reflection cross-section areas σᵢ at the respective reflection points calculated using the expression (6) is calculated using an expression (8). Then, the summation calculated is defined as the size indicator S for indicating size of the body.
[Expression 3]

$$S = W + \frac{{\sum }_{i} {σ}_{i}}{k} \qquad ( 8 )$$

When the radar device 1 is selected as the reference, the larger the transverse width W of the detected body 14 is, the larger value the size indicator S calculated using the expression (8) takes on. As having been described earlier, the transverse width W may be used instead of this size indicator S. In this embodiment, however, the average value σᵢ/k of the reflection cross-section areas is added thereto. This is because visual impression that the obstruction body makes on the driver is taken into consideration.

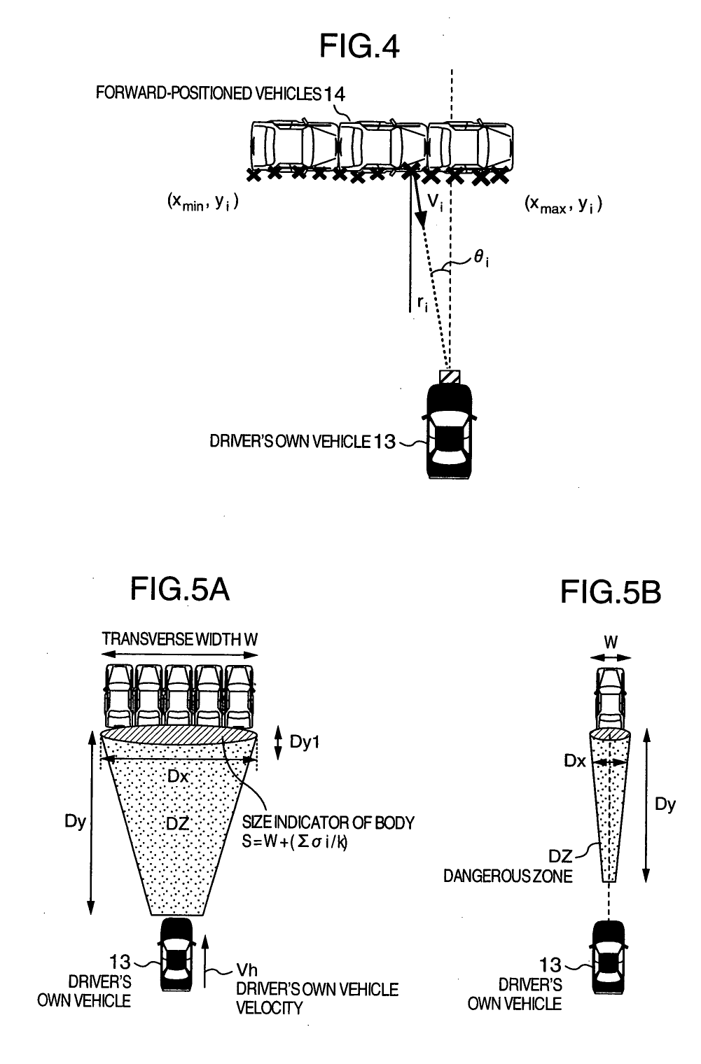

FIG. 4 illustrates a plan view for illustrating an example of the operation situation where the vehicle-mounted radar device 1 detects the forward-positioned bodies 14. When the bodies 14 exist forward of the driver's own vehicle 13 in succession, reflected waves return from the whole of the bodies 14, and accordingly much more reflection points are detected. Position information at these large number of reflection points is calculated, and, based on the above-described method, size indicator S of the bodies 14 is acquired. In this case, transverse width W of the forward-positioned bodies 14 is larger as compared with the case in FIG. 3A, and accordingly the size indicator S of the bodies 14 also becomes larger.

Next, using the calculated transverse width W or size indicator S of the body, the possibility is computed that the driver's own vehicle 13 and the body 14 will collide with each other. Then, depending on the result, the explanation will be given below concerning a method of performing control over the steering, brake, and/or power-steer.

First, into the vehicle control ECU 2 in FIG. 1, the wheel speed V of the driver's own vehicle 13 are inputted from the vehicle-speed sensors 3. The vehicle-speed sensors 3 can be implemented with wheel-speed sensors attached to the four wheels. Here, average value of the wheel speed is defined as driver's own vehicle speed Vh. Also, the vehicle-speed sensors 3 can be implemented with a ground speed sensor. In this sensor, a millimeter-wave radar is mounted on lower portion of the vehicle, and electromagnetic wave is transmitted toward the ground to receive the reflected wave, thereby directly measuring the driver's own vehicle speed Vh with reference to the ground. The ground speed sensor is effective in detecting movement of the driver's own vehicle, since this sensor makes it possible to measure the driver's own vehicle speed with reference to the ground even when the tires slip because of rain or snow-lying road.

Next, the dangerous zone DZ is computed, using the driver's own vehicle speed Vh, and the information on the transverse width W of the detected body 14 calculated using the expression (7). Here, the dangerous zone DZ refers to a zone on the plane coordinate system within which the driver's own vehicle 13 will collide with the body 14 if the vehicle 13 continues to travel with the present velocity Vh and steering angle maintained. Letting longitudinal-direction length and transverse-direction length of this zone DZ be Dy and Dx respectively, Dx and Dy are defined as are given by the following expressions (9) and (10):
Dx=W (9)
Dy=k1·vh+2·W (10)

Here, k1 and k2 denote constants.

FIG. 5 illustrates a plan view for illustrating a method for setting the dangerous zone DZ which is dangerous in view of the present status of the driver's own vehicle 13. In FIG. 5A, when making a comparison between the case of the driver's own vehicle speed Vh=50 km/h and the case of Vh=100 km/h, the length Dy of the dangerous zone DZ becomes longer in the case of Vh=100 km/h. In the case of the driver's own vehicle speed Vh=60 km/h as well, the length Dy of the dangerous zone DZ becomes longer in the case where the transverse width W of the body is wide as is illustrated in FIG. 5A than in the case where the transverse width W of the body is narrow as is illustrated in FIG. 5B.

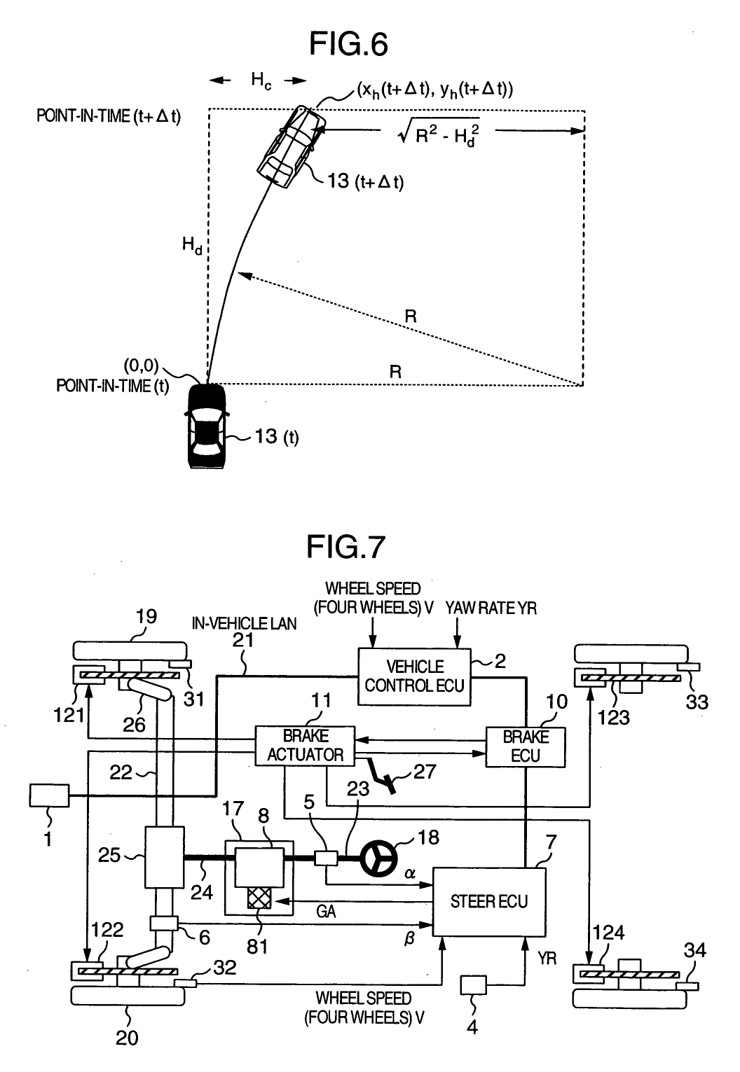

FIG. 6 illustrates a plan view for explaining an estimation method for estimating position of the driver's own vehicle 13 which accompanies time variation. First, the driver's own vehicle position at a point-in-time Δt after is calculated as follows: Assuming that rotational angular-velocity (i.e., yaw rate) of the vehicle 13 around its center of mass calculated using the gyro 4 is equal to ω [rad/s], curve radius R, which becomes traveling path of the driver's own vehicle, can be determined using the driver's own vehicle speed Vh and an expression (11).
R=Vh/ω (11)

Accordingly, transverse-direction distance Hc and longitudinal-direction distance Hd illustrated in FIG. 6, which are covered by the driver's own vehicle 13 from a position P (t) of the vehicle 13 at a point-in-time t to the position P (t+Δt) of the vehicle 13 at the point-in-time Δt after (t+Δt), are calculated by the following expressions (12) and (13) respectively:

[Expression 4]
Hc=R−\sqrt{R²−Hd²} (12)
[Expression 5]
Hd≈VhΔt (13)

Consequently, when defining transmission/reception point of the radar device 1 at the point-in-time t as the point of origin (0, 0), coordinate of the position P (t+Δt) of the driver's own vehicle 13 Δt [s] after is represented by an expression (14).

[Expression 6]
(R−\sqrt{R²(VhΔt)²}, VhΔt) (14)

If, using the results calculated above, the driver's own vehicle position Δt [s] after has been found to be within the above-described dangerous zone DZ, the driver's own vehicle 13 judges that the vehicle 13 is in a danger of colliding with the forward-positioned body 14. Accordingly, in the following way, the driver's own vehicle 13 performs the controls for avoiding the collision. Namely, the steer ECU 7 controls the VGR mechanism 8 and the power-steer 9, and/or the brake ECU 10 adjusts the brake 12 via the brake actuator 11.

When the vehicle 13 is in the danger of colliding with the forward-positioned obstruction body 14, the driver steps on the brake or performs handle operation in order to avoid the collision. If, however, there exists necessity for changing the steering angle so rapidly, dependence on power by the driver alone necessitates time, thereby resulting in the danger of actual collision. Then, in order to avoid the collision without fail, the following controls are performed so that, in response to the transverse width W or size indicator S of the detected body 14, the steering into a collision avoidance direction will be made easier with the small operation amount.
1) adjustment of the steering gear ratio G
2) control over correlation relationship between right and left brake forces
3) adjustment of the steering gear ratio, and control over correlation relationship between right and left brake forces
4) adjustment of the steering gear ratio, and adjustment of the power-steer assistance force, or
5) adjustment of the steering gear ratio, adjustment of the power-steer assistance force, and control over correlation relationship between right and left brake forces.

FIG. 7 illustrates a configuration diagram of a concrete embodiment of the present invention which, as a steering driving-force transmission mechanism, uses a power-steer driving-force transmission mechanism 17 equipped with the VGR (: Variable Gear Ratio) mechanism 8. In this embodiment, the steering driving-force transmission mechanism 17 equipped with the variable gear ratio (VGR: Variable Gear Ratio) mechanism 8 for making the steering gear ratio variable is provided between a handle (i.e., steering wheel) 18 and the steered wheels 19 and 20. Consequently, it becomes possible to adjust the ratio between the operation amount α of the handle 18 and the actual steering angle β of the steered wheels 19 and 20, i.e., the steering gear ratio G.

First, as a control example of the steering gear ratio G, the explanation will be given below regarding a method of controlling only the steering driving-force transmission mechanism 17 equipped with the VGR mechanism 8. In this embodiment, the radar device (i.e., body detection unit) 1, the vehicle control ECU 2, the steer ECU 7, and the brake ECU 10 are connected to each other by an in-vehicle LAN 21 indicated by the heavy solid line. This connection allows exchanges of information among these respective units.

The vehicle control ECU 2 inputs, into the steer ECU 7, the computed size indicator S including the transverse width W of the forward-positioned body 14, and the wheel speed V detected by the vehicle-speed sensors 3 (i.e., 31 to 34). Also, the vehicle control ECU 2 detects the rotation amount α of the handle 18 by using the handle angle sensor 5, and measures the actual steering angle β of the steered wheels 19 and 20 by using the steering angle sensor 6 for detecting variation in a tie rod 22. Then, the ECU 2 inputs the amount α and the angle β into the steer ECU 7 each. When issuing the danger signal DS, the vehicle control ECU 2 outputs, to the steer ECU 7, the size indicator S including the transverse width W of the forward-positioned body 14 as well.

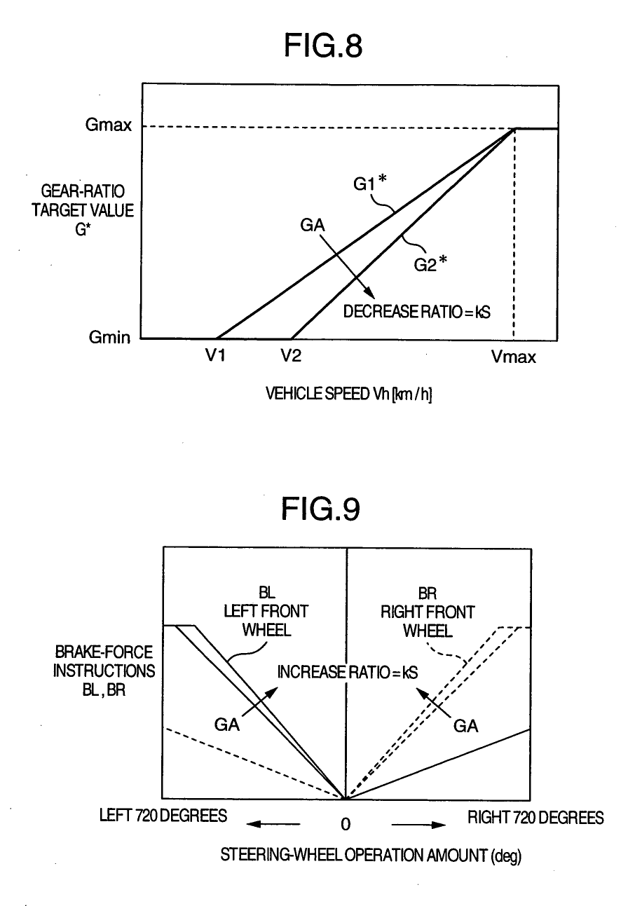

As illustrated in FIG. 8 for example, the steer ECU 7 computes the target value G* of the steering gear ratio G from relationship between the driver's own vehicle speed Vh and the steering gear ratio G.

FIG. 8 illustrates a diagram for explaining a set example of the target value G* of the steering gear ratio G with respect to the driver's own vehicle speed Vh in an embodiment of the present invention. Steering characteristics are based on the VGR mechanism 8 which is capable of making the steering gear ratio G variable in response to the driver's own vehicle speed Vh. Tolerable variation range of the steering gear ratio G is Gmin to Gmax. The characteristic of the usual target value G* of the steering gear ratio G is represented by G1*. Namely, when the driving velocity Vh falls in the range of 0 to V1 [km/h], the gear-ratio target value G* is set at the minimum Gmin. Also, the velocity Vh falls in V1 to Vmax, the gear-ratio target value G* is so set as to get increasingly larger in proportion to the increase in the velocity Vh within the range up to Gmax. Also, when the velocity Vh is larger than Vmax, the gear-ratio target value G* is fixed at the tolerable maximum value Gmax.

Here, notation G2* represents gear-ratio target value at the time of emergency when the danger of collision with the forward-positioned obstruction body 14 is detected and thus the danger signal DS occurs. Namely, in response to the size indicator S of the detected obstruction body 14, the gear-ratio target value G* is so changed as to become a smaller value. If the size indicator S of the obstruction body 14 is small, this decrease ratio is also small. The larger the size indicator S gets, the larger this decrease ratio becomes.

As having been described previously, if the steering gear ratio G is made small, the steering angle β of the steered wheels 19 and 20 which is larger than usual can be acquired with the small operation amount α of the handle 18. The handle 18 is fixed onto an input rotation axis 23 of a steering shaft. Within the driving-force transmission mechanism 17, there is provided the VGR mechanism 8 which makes the input/output gear ratio variable by using, e.g., worm gear. In a steering gear box 25, an output rotation axis 24 of the driving-force transmission mechanism 17 is connected to the tie rod 22 by a rack and a pinion mechanism. Rotation of the output rotation axis 24 is converted into displacement of the tie rod 22 in the axis direction. The displacement of the tie rod 22 is transmitted to the steered wheels 19 and 20 via a link mechanism 26. Incidentally, the power steering mechanism is not illustrated, since the mechanism is assumed to exist inside the gear box 25. Numeral 27 denotes a brake pedal.

As having been explained previously referring to FIG. 1, the VGR mechanism 8 inside the driving-force transmission mechanism 17 adjusts the steering gear ratio G by using the motor 81. If no instruction has been issued from the steer ECU 7, the motor 81 is in no motion, and the gear ratio G has been determined based on, e.g., the target value G1* in FIG. 8. Here, if, based on the danger signal DS from the vehicle control ECU 2, the gear-ratio adjustment instruction GA has been given to the VGR mechanism 8 from the steer ECU 7, the motor 81 of the VGR mechanism 8 is rotated, thereby adjusting the input/output gear ratio to, e.g., the characteristic G2* in response to the size indicator S of the obstruction body 14. This makes the gear ratio G smaller. As a result, the large steering angle β of the steered wheels 19 and 20 can be acquired with the comparatively small handle operation amount α. Consequently, it becomes possible to corner the vehicle largely and thereby to avoid the obstruction body easily.

Incidentally, as a modified embodiment, the following control method may also be employed: In the steer ECU 7, from vehicle movement state or driver's intention estimated based on output values from the respective sensors, target steering angle of the steered wheels 19 and 20 which is preferable at the point-in-time is computed. Next, this target steering angle is compared with the output from the steering angle sensor 6. Then, if the output does not coincide with the target steering angle, the motor 81 of the VGR mechanism 8 is controlled so that the steering angle β of the steered wheels 19 and 20 will coincide with the target steering angle. The configuration like this, similarly to the above-described case, also makes it easy to avoid the obstruction body.

As explained above, if the transverse width W of the obstruction body is not large, the gear ratio G is not decreased more than required, thereby preventing the driver from turning the handle too much. This makes it possible to reduce over-operation, thereby allowing the implementation of an enhancement in driving operability and safety.

Also, in order to prevent the gear ratio from being changed while the driver is in the middle of operating the handle, changing the gear ratio is performed when the handle is positioned within range of neutral points α1 [deg]. Namely, the steering angle α of the handle is calculated in advance using the steering-wheel angle sensor 5. Then, it is determined that the gear ratio is permitted to be changed only within the range that the steering angle α is in −α1 to +α1. It is desirable that the setting at, e.g., about α1=5 degrees be performed.

FIG. 9 illustrates a diagram for explaining a set example of brake-force instructions BL and BR with respect to the handle operation amount α in an embodiment of the present invention. In this example, first of all, in response to the handle operation in the usual state, the brake force in that direction is made stronger than the one in the other direction, thereby making cornering of the vehicle easier. For example, if the driver turns the handle to the left, the vehicle displaces to the left from the center in FIG. 9 in response to the handle operation α. At this time, the brake-force instruction BL for left front-wheel indicated by the solid line is so set as to become larger than the brake-force instruction BR for right front-wheel indicated by the broken line.

Here, if the obstruction body exists forward of the vehicle and the above-described danger signal DS has occurred, adjustment of the brake force for making even easier the cornering of the vehicle in response to the handle operation is further performed. Namely, when the driver tries to turn the vehicle, e.g., to the left to avoid this obstruction body by the handle operation, if the danger signal DS exists, the brake-force instruction BL for left front-wheel is increased even further as is illustrated in left-half in FIG. 9. The larger the size indicator S of the forward-positioned obstruction body is, the larger this increase ratio is made.

Accordingly, the brake force in the direction of the handle operation by the driver is increased even further. As a result, difference between the right and left brake forces is enlarged with the comparatively small handle operation amount a. Consequently, it becomes possible to corner the vehicle 13 largely and thereby to avoid the obstruction body easily. What is more, the total brake force is increased, thereby allowing the implementation of an even further enhancement in the safety.

Next, the explanation will be given below concerning computation processing in the vehicle control ECU 2 according to an embodiment of the present invention.

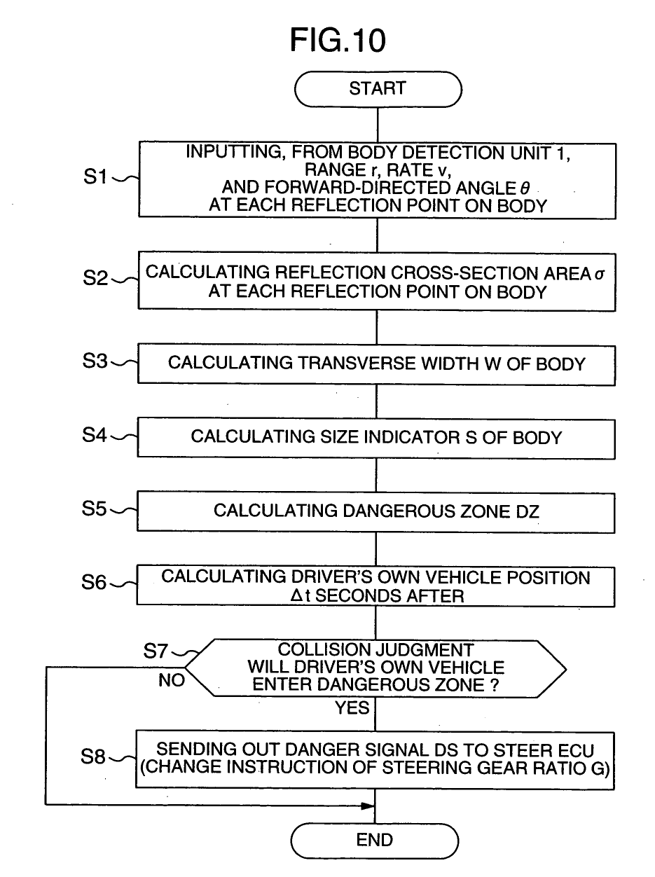

FIG. 10 illustrates a processing flow for illustrating a first embodiment of the computation processing in the vehicle control ECU 2. In this embodiment, the computation processing is performed towards the respective signals acquired from the radar device 1 in FIG. 1 and the detected signals from the sensors. Then, if the danger of collision has been predicted, the adjustment of the steering gear ratio G is performed.

First, at a step S1, the relative velocity v, distance r, and angle θ are inputted from the radar device (body detection unit) 1. At a step S2, the reflection cross-section area σ at each reflection point is calculated. Also, at a step S3, the transverse width W of the obstruction body 14 is calculated by the earlier-described expression (7). At a step S4, the size indicator S of the obstruction body is computed by the earlier-described expression (8). Next, at a step S5, the dangerous zone DZ is determined using the calculated transverse width W or size indicator S of the body 14. At a step S6, the driver's own vehicle position Δt seconds after is calculated from the traveling direction and velocity of the driver's own vehicle 13. Receiving this position, at a step S7, the possibility of collision is computed from whether or not the driver's own vehicle 13 will dash into the dangerous zone DZ based on the obstruction body 14. Depending on the result, at a step 8, the danger signal DS is sent out to the steer ECU 7, and then the steer ECU 7 issues the change instruction of the target value G* of the steering gear ratio.

Concerning the change of the target value G* of the steering gear ratio, the explanation has been just given earlier. Namely, decreasing the target value G* of the steering gear ratio makes it possible to enlarge the actual steering angle even if the handle operation angle itself is the same for the driver. On account of this, when the driver tries to avoid the collision with the obstruction body, the avoidance operation becomes easier.

Next, the explanation will be given below regarding an embodiment of the present invention which uses the brake control. In this embodiment, if it has been judged that there exists the possibility of collision with the forward-positioned obstruction body, correlation relationship between the right and left brake forces is adjusted in response to the handle operation amount. In this case, the brake ECU 10 and the brake actuator 11 control the brake 12 in the following way:

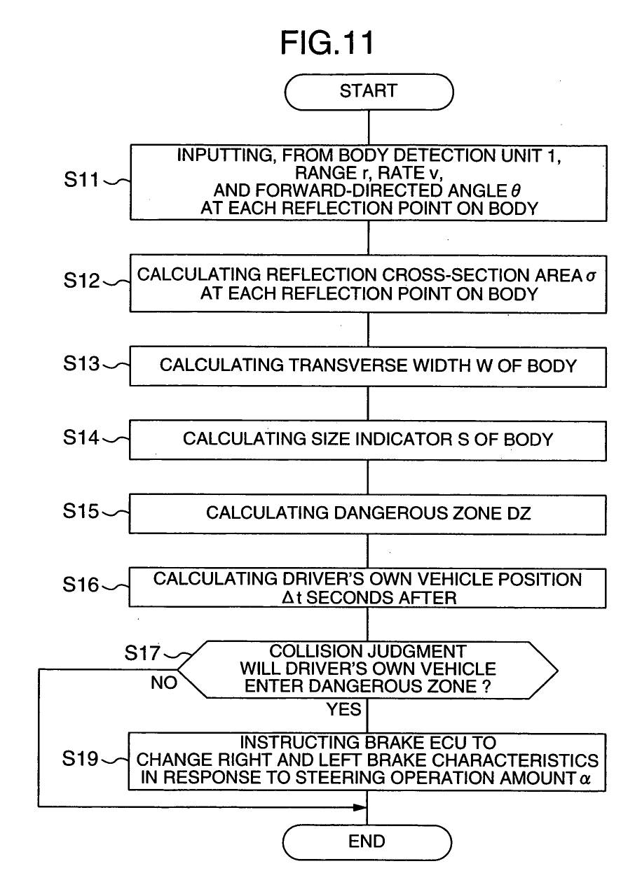

FIG. 11 illustrates a processing flow for illustrating a second embodiment of the computation processing in the vehicle control ECU 2. In FIG. 11, processings at steps 11 to 17 are the same as those in FIG. 10. At the step 17, the danger of collision is predicted. At a step 19, based on this prediction, the danger signal DS is sent out to the brake ECU 10. Then, the brake ECU 10 controls the brake 12 via the brake actuator 11, thereby assisting collision avoidance to the obstruction body.

Regarding the adjustment of the correlation relationship between the brake forces, the explanation has been just given earlier. Namely, increasing the brake force in a direction in which the handle has been operated makes it possible to enlarge the actual cornering of the vehicle even if the handle operation itself is the same for the driver. On account of this, when the driver tries to avoid the collision with the obstruction body, the avoidance operation becomes easier.

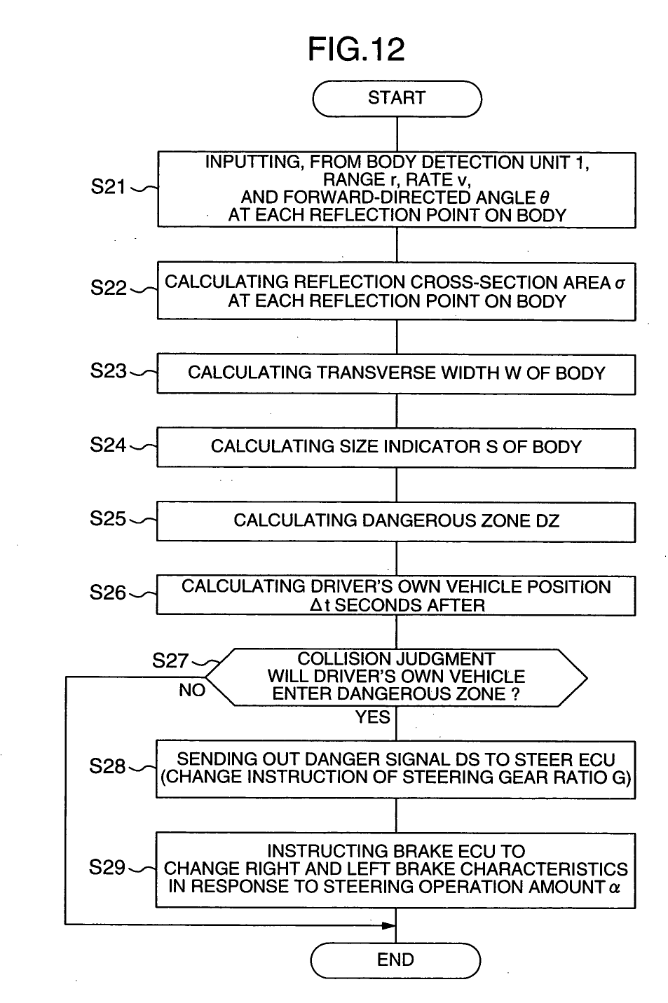

FIG. 12 illustrates a processing flow for illustrating a third embodiment of the computation processing in the vehicle control ECU 2. In this embodiment, if the danger of collision has been predicted, the adjustment of the steering gear ratio G and the adjustment of the correlation relationship between the right and left brake forces are performed. In FIG. 12, processings at steps 21 to 27 are the same as those in FIG. 10 and FIG. 11. At the step 27, the danger of collision is predicted. At a step 28, based on this prediction, the danger signal DS is sent out to the steer ECU 7, and then the steer ECU 7 issues the change instruction of the target value G* of the steering gear ratio. Also, at a step 29, the danger signal DS is sent out to the brake ECU 10 as well, and then the brake ECU 10 issues the adjustment instructions of the correlation relationship between the right and left brake forces in response to the handle (i.e., steering) operation amount α.

Concerning the change of the target value G* of the steering gear ratio and the adjustment of the correlation relationship between the brake forces, the explanation has been just given earlier. This decreases the target value G* of the steering gear ratio, thereby making it possible to enlarge the actual steering angle even if the handle operation angle itself is the same for the driver. Also, simultaneously, increasing the brake force in a direction in which the handle has been operated makes it possible to enlarge the actual cornering of the vehicle even if the handle operation itself is the same for the driver. On account of this, when the driver tries to avoid the collision with the obstruction body, the avoidance operation becomes even easier.

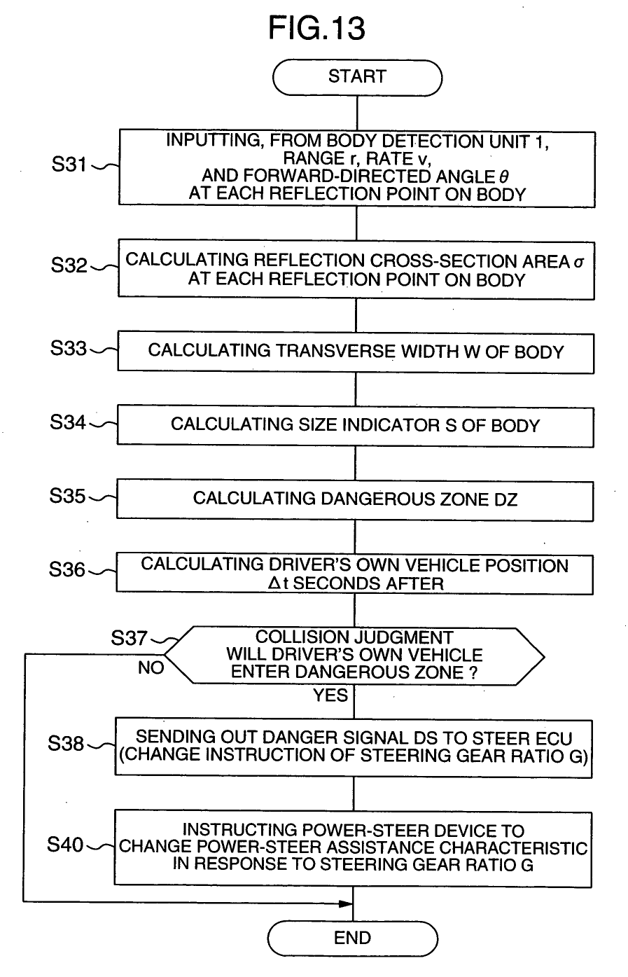

FIG. 13 illustrates a processing flow for illustrating a fourth embodiment of the computation processing in the vehicle control ECU 2. In this embodiment, if the danger of collision has been predicted, the adjustment of the steering gear ratio G and the power-steer assistance by the power steering device are performed. In FIG. 13, processings at steps 31 to 38 are the same as those in FIG. 10 and FIG. 12. At the step 37, the danger of collision is predicted. At the step 38, based on this prediction, the danger signal DS is sent out to the steer ECU 7, and then the steer ECU 7 issues the change instruction of the target value G* of the steering gear ratio. In addition to this, at a step 40, the steer ECU instructs the power steering device to change the power-steer assistance characteristic in response to the steering gear ratio G. As described earlier, decreasing the target value G* of the steering gear ratio makes it possible to acquire the large steering angle of the steered wheels with the small handle operation. However, there exists possibility that the handle becomes heavy by this large steering angle. Accordingly, the power-steer assistance force is increased in proportion to the target value G* of the gear ratio so that the handle will be able to be turned with the small force.

This makes it possible to enlarge the actual steering angle of the steered wheels of the vehicle even if the handle operation itself is performed with the same arm force for the driver. On account of this, when the driver tries to avoid the collision with the obstruction body, the avoidance operation becomes even easier.

Also, although not illustrated, all of the steps S8, S19, S28, S29, S38, and S40 in FIGS. 10 to 13 can be provided at the same time. It can be understood easily that this makes it possible to assist the driver's avoidance operation even further.

In the embodiments described so far, the explanation has been given selecting the example where the collision of the vehicle is detected using the radar device. In, e.g., the body detection unit, however, the configuration may also be given such that periphery of the driver's own vehicle is recognized using an image processing device.

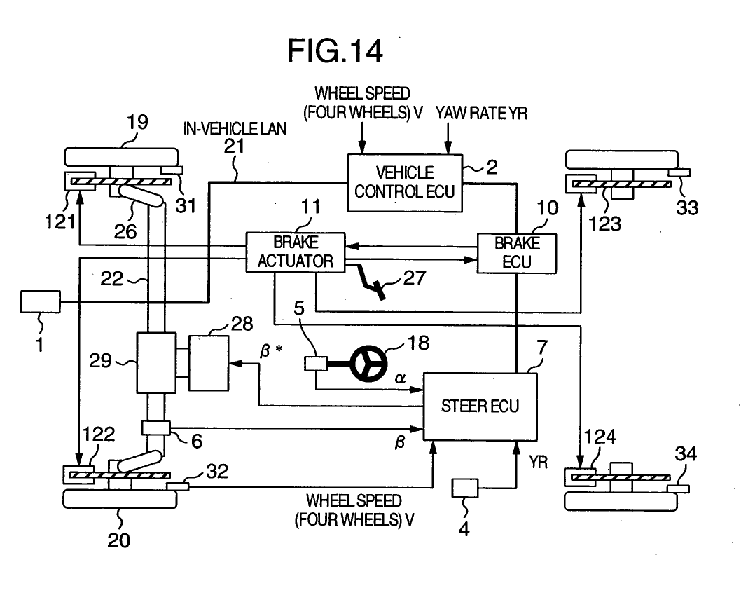

FIG. 14 illustrates a configuration diagram for illustrating a concrete embodiment of the present invention which uses a SBW (: Steer By Wire)-schemed steering driving-force transmission mechanism 29. In this embodiment, the handle 18 is not connected to the steered wheels 19 and 20 mechanically. The operation angle α of the handle 18 is detected by the steering-wheel angle sensor 5, then being inputted into the steer ECU 7. The actual steering angle β of the steered wheels 19 and 20 is also inputted into the steer ECU 7 from the steering angle sensor 6. Then, the steer ECU 7 sends out a steering-angle target value β* to a driving mechanism 28 under all the computations described in the embodiments so far. The driving mechanism 28 drives the SBW-schemed steering driving-force transmission mechanism 29 in response to this steering-angle target value β*, thereby controlling the mechanism 29 so that the actual steering angle β of the steered wheels will become equal to the target value β*.

It is needless to say that, in this embodiment as well, all the controls described so far are applicable in much the same way.

It should be further understood by those skilled in the art that although the foregoing description has been made on embodiments of the invention, the invention is not limited thereto and various changes and modifications may be made without departing from the spirit of the invention and the scope of the appended claims.

1. A vehicle driving control device, comprising:
body detection means for detecting a body existing forward of a driver's own vehicle,
driver's own vehicle speed detection means for detecting velocity of said driver's own vehicle,
a steering control mechanism for controlling steering angle of steered wheels on the basis of operation of a steering wheel,
body-size detection means for detecting size of said body, and
control-characteristics change means for changing control characteristics of said steering control mechanism on the basis of position information on said body detected by said body detection means, said size information on said body, and said velocity information on said driver's own vehicle.

2. The vehicle driving control device according to claim 1, wherein said size of said body includes transverse-width component of said body measured in a horizontal direction which is substantially perpendicular to a traveling direction of said driver's own vehicle, said size of said body being detected by said body-size detection means.

3. The vehicle driving control device according to claim 1, wherein said body detection means includes a radar for emitting radio wave, said size of said body being detected by said body-size detection means, said size of said body also including broadness component of a reflection plane of said traveling wave emitted from said radar of said driver's own vehicle.

4. The vehicle driving control device according to claim 1, wherein said control-characteristics change means comprises means for changing said steering angle of said steered wheels with respect to operation amount of said steering wheel so that said steering angle will become larger in response to said size of said body.

5. The vehicle driving control device according to claim 1, wherein said control-characteristics change means comprises means for changing assistance force by a power steering device so that said assistance force will become larger in response to said size of said body.

6. The vehicle driving control device according to claim 1, wherein said control-characteristics change means comprises means for changing said steering angle of said steered wheels with respect to operation amount of said steering wheel so that said steering angle will become larger in response to said size of said body, said control-characteristics change means also comprising means for changing assistance force by a power steering device so that said assistance force will become larger in response to said size of said body.

7. The vehicle driving control device according to claim 1, further comprising means for exerting braking force onto a front wheel positioned in a direction in which said steering wheel has been operated, said braking force being larger than braking force exerted onto the other front wheel.

8. The vehicle driving control device according to claim 4, wherein said means activates when said steering wheel is positioned in range falling within a predetermined value from a neutral point, said means being designed for changing said steering angle of said steered wheels with respect to said operation amount of said steering wheel so that said steering angle will become larger.

9. The vehicle driving control device according to claim 1, further comprising
steering-angle detection means for detecting said steering angle of said steered wheels of said driver's own vehicle,
dangerous-zone computation means for computing a zone on the basis of said position of said body, said size of said body, said driver's own vehicle speed, and said steering angle of said steered wheels, said zone being dangerous for said driver's own vehicle, and
danger prediction means for activating said control-characteristics change means by predicting danger of collision of said driver's own vehicle with said body on the basis of this dangerous-zone information.

10. A vehicle driving control device, comprising:
body detection means for detecting a body existing forward of a driver's own vehicle,
driver's own vehicle speed detection means for detecting velocity of said driver's own vehicle,
a steering control mechanism for controlling steering angle of steered wheels on the basis of operation of a steering wheel,
body-size detection means for detecting size of said body, and
brake control-characteristics change means for changing correlation control characteristics of right and left brake forces with respect to said operation of said steering wheel on the basis of position information on said body detected by said body detection means, said size information on said body, and said velocity information on said driver's own vehicle.

11. The vehicle driving control device according to claim 10, wherein said size of said body includes transverse-width component of said body measured in a horizontal direction which is substantially perpendicular to a traveling direction of said driver's own vehicle, said size of said body being detected by said body-size detection means.

12. The vehicle driving control device according to claim 10, wherein said body detection means includes a radar for emitting radio wave, said size of said body being detected by said body-size detection means, said size of said body also including broadness component of a reflection plane of said traveling wave emitted from said radar of said driver's own vehicle.

13. The vehicle driving control device according to claim 10, wherein said control-characteristics change means comprises means for changing said steering angle of said steered wheels with respect to operation amount of said steering wheel so that said steering angle will become larger in response to said size of said body.

14. The vehicle driving control device according to claim 10, wherein said control-characteristics change means comprises means for changing said steering angle of said steered wheels with respect to operation amount of said steering wheel so that said steering angle will become larger in response to said size of said body, said control-characteristics change means also comprising means for changing assistance force by a power steering device so that said assistance force will become larger in response to said size of said body.

15. The vehicle driving control device according to claim 13, wherein said means activates when said steering wheel is positioned in range falling within a predetermined value from a neutral point, said means being designed for changing said steering angle of said steered wheels with respect to said operation amount of said steering wheel so that said steering angle will become larger.

16. The vehicle driving control device according to claim 10, further comprising
steering-angle detection means for detecting said steering angle of said steered wheels of said driver's own vehicle,
dangerous-zone computation means for computing a zone on the basis of said position of said body, said size of said body, said driver's own vehicle speed, and said steering angle of said steered wheels, said zone being dangerous for said driver's own vehicle, and
danger prediction means for activating said control-characteristics change means by predicting danger of collision of said driver's own vehicle with said body on the basis of this dangerous-zone information.

17. The vehicle driving control device according to claim 10, further comprising means for exerting braking force onto a front wheel positioned in a direction in which said steering wheel has been operated, said braking force being larger than braking force exerted onto the other front wheel.

18. The vehicle driving control device according to claim 10, further comprising means for increasing braking force exerted onto a front wheel positioned in a direction in which said steering wheel has been operated in response to operation angle of said steering wheel, and for enlarging increase ratio of said braking force with respect to said operation angle in response to said size of said body.

19. A vehicle control unit for inputting at least distance information up to a body from body detection means, relative-velocity information between said body and a driver's own vehicle, and velocity information on said driver's own vehicle detected from driver's own vehicle speed detection means, and for outputting at least a signal for instructing characteristics change on steering of said vehicle, and a size signal including transverse width of said body.

20. The vehicle control unit according to claim 19, which outputs information on operation amount of a steering wheel, and information on target value of steering gear ratio, said steering gear ratio being defined as ratio of steering angle of steered wheels with respect to said operation amount of said steering wheel.
